(19) United States
(12) Patent Application Publication
(10) Pub. No.: US 2013/0256209 A1
(43) Pub. Date: Oct. 3, 2013

(54) MEMBRANE FOR REVERSE OSMOSIS

(71) Applicant: Manfred Volker, Blankenbach (DE)

(72) Inventor: Manfred Volker, Blankenbach (DE)

(21) Appl. No.: 13/851,139

(22) Filed: Mar. 27, 2013

(30) Foreign Application Priority Data
Mar. 28, 2012 (DE) 102012006320.2

(51) Int. Cl. C02F 1/44

(52) U.S. Cl. CPC C02F 1/441
USPC 210/321.6

(57) ABSTRACT

Reverse-osmosis modules, each containing a module tube with a module bottom and a module lid, and a reverse osmosis membrane arranged in the module tube and comprising a permeate collection tube, are characterized in that the reverse osmosis membrane has a fixed predetermined diameter and a length selected from predetermined length values.

Different ultrapure-water volumes are needed for the supply of liquid to hemodialysis devices. Depending on the equipment of the dialysis centers or the treatment places, it may happen that a number of one to fifty hemodialysis devices or more are installed. At the moment the ultrapure water supply is implemented by way of reverse osmosis systems with different membranes, the differences regarding diameter and also length values as well as the type of connection of the module tubes.

It is the aim of the invention to indicate inexpensive reverse-osmosis modules for a large ultrapure-water supply sector, particularly for the supply of hemodialysis treatments.

To avoid bacterial contamination as well as other biological deposits and to improve flushing and disinfection, respectively, another object to be achieved by this invention consists in ensuring the absence of dead spaces, both in the primary and in the secondary area of the membrane.

The invention also aims at providing a module unit consisting of a membrane installed into a module tube, which module unit can be connected hydraulically with the help of very simple means without any great installation efforts or can be interconnected to form module stations of increased capacity.

Moreover, also in the case of small production quantities the manufacturing costs of the membrane should not be above those of the standard membranes produced in great quantities.

This object is achieved according to the invention by the features of patent claim 1.

Advantageous configurations of the invention are characterized in the sub-claims.

The invention provides reverse osmosis membranes having a uniform diameter and at least three different lengths, which are respectively inserted in a pressure tube through which liquid is flowing without any dead spaces, and which have the same diameter, but different lengths, and thus become a reverse osmosis module which, while being used in reverse osmosis processes showing different performances, operates single, but also plural, hemodialysis devices with ultrapure water.

The invention preferably provides membrane dimensions with a diameter of 4.7 inches to 5 inches, preferably 4.9 inches, and possible length values of about 40 inches, 23 inches and 12 inches with liter capacities per hour of about 500 l, 250 l, and 100, respectively.

The membrane areas should here be adapted such that the transmembranic flow between 30 l/m² and 40 l/m² is preferably about 33 l/m² to achieve an operating period that is as long as possible or low wear of the membrane surface, respectively, also in the case of contaminated raw or untreated water.

The retention rate of the sodium salts should here be more than 99%. The material is of such a type that a temperature for hot sanitization of about 85° C. is possible.

A dimensioning deviating from the membrane development and the respectively needed ultrapure water qualities both in the liter capacity and in the diameter is within the scope of this invention if membranes of the same diameter are concerned and the maximum length thereof does not exceed 43 inches each time, or their smallest length is a fraction thereof.

At any rate, with the uniform diameter and with preferably three different membrane lengths, reverse osmosis systems shall very advantageously be produced with the same hydraulic membrane connections, which particularly encompass all treatment capacities occurring in dialysis, ranging from the single station in the case of home patients to large dialysis stations with more than 50 places.

To increase the capacity, the membranes can here be combined by serial and/or parallel connection to form membrane stations.

Further data of relevance to the specification of the membranes and the installation thereof are depicted in the figures listed hereinafter.

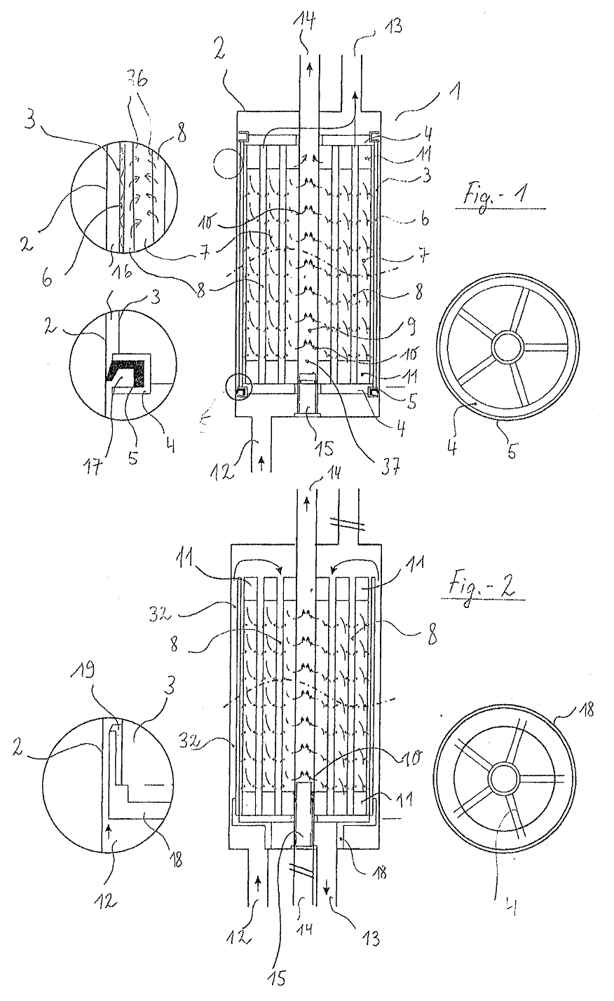

FIG. 1 scheme of a standard membrane in the pressure tube

FIG. 2 scheme of a new membrane in the pressure tube

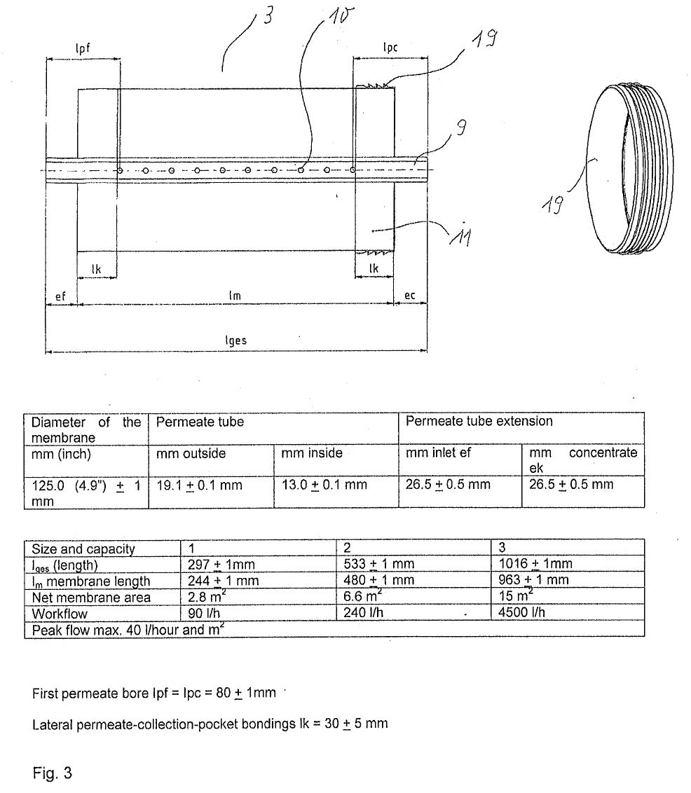

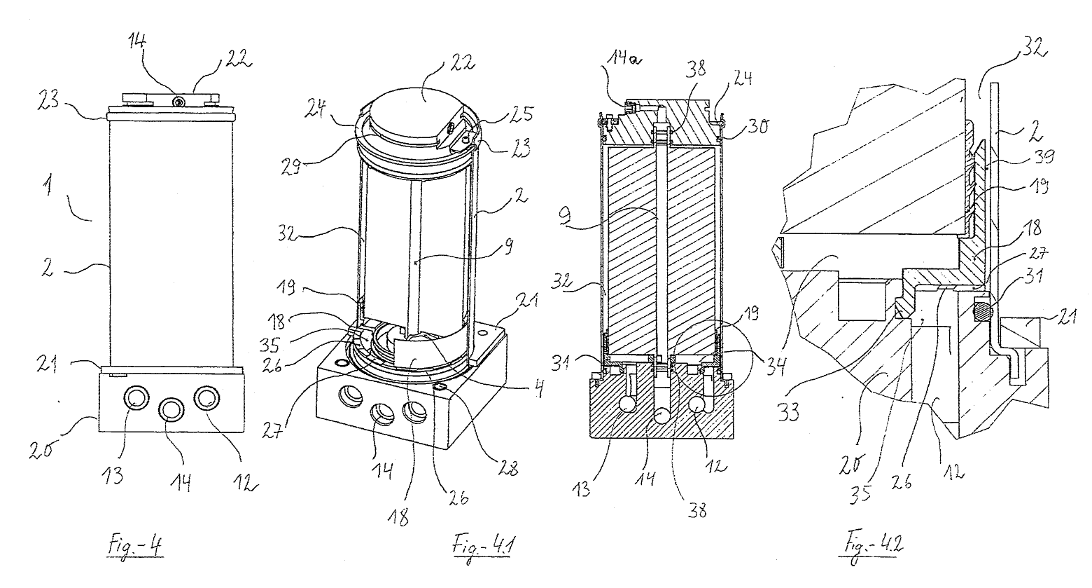

FIG. 3 dimensions of the new membrane

FIG. 4 module unit

FIG. 4.1 sections of the module unit

FIG. 4.2 detail of the sealing of the membrane in the module unit

FIG. 1 shows a reverse osmosis module (1) consisting of a reverse-osmosis membrane (3) which is installed in a module tube (2) in form-fit fashion by means of lip seal (5).

The feed water is supplied via connection (12) into the module tube (2) in such a manner that the lip seal (5) closes the module dead space (16), i.e., the space between module tube inside and membrane cover layer (6), so that the supplied liquid is fed for reasons of energy solely via the feed water channels (8). To support the feed water channels (8) between the permeate collection pockets (7), a plastic fabric which is advantageous under flow aspects is installed.

The feed water leaves the module tube (2) as a concentrate via connection (13).

Due to a flow resistance (not shown here) in the concentrate discharge (13) the supplied feed water is passed by means of pressure via the active membrane (36) into the permeate collection pockets (7).

Plural permeate collection pockets (7) are spirally wound around the permeate collection tube (9). Advantageously, there are about 9 pockets in the case of the intended solution. The permeate collection pockets (7) have an open end on the permeate collection tube (9) and are adhesively bonded (11) on the remaining three sides, so that the filtered permeate can flow out of the permeate collection pockets (7) via permeate bores (10) into the permeate collection tube (9). The permeate collection pockets have inserted therein a plastic or synthetic fabric which is advantageous under flow aspects and which serves to support and also to pass on the filtered permeate to the collection tube (9). As for the membranes (3) described in the invention, the permeate collection pockets (7) are fastened at an angle of about 60° in overlapping fashion to the collection tube (9). The outer jacket of the membrane (3), the membrane cover layer (6), is water-impermeable.

The permeate leaves the module tube (2) via connection (14). The other end of the permeate collection tube (9) is sealed by means of a closure (15). To avoid telescoping of the spirally wound membrane, the two ends of the reverse osmosis membrane (3) have mounted thereon the anti-telescoping stars (4) which also include an accommodation of the lip seal (5).

The prior art is disadvantageous insofar as there are dead spaces (17) inside the lip seal (5), (16) between pressure tube inside and membrane top side over the whole length of the membrane and dead spaces (37) in the permeate collection tube between closure (15) and the first permeate bores (10).

FIG. 2 shows two possibilities for preventing the dead space shown in FIG. 1 within the permeate collection tube (9). The plug (15) is extended up to the first permeate bore (10); moreover, the module tube (2) or the connection unit thereof is provided with a further connection (14), so that liquid can flow through the permeate collection tube (9) in both directions by removing the plug (15).

Preferably, the concentrate connection (13) is also mounted on the same end of the module tube (2) or the connection unit thereof so that all connections (12, 13, 14) are positioned at one side of the module tube (2).

To avoid the dead space (16), the reverse osmosis membrane (3) is inserted into a membrane collar (18) which is an integral part of the module tube connection unit. The membrane is sealed by a large-area seal ring (19) in the membrane collar (18). The supplied feed water flows here without any additional energetic efforts through the whole module ring gap (32) and then terminates in the feed water channels (8).

However, in order to avoid membrane telescoping in flow direction, the membrane collar (18) is equipped with a star (4), or also with another form that is equivalent in terms of flow and construction. The anti-telescoping element has an outer ring and an inner ring through which the permeate collection tube is extending. The two rings are connected by webs that are spaced apart from one another and preferably extend in star-shaped configuration. Thanks to the anti-telescoping membrane the production process is considerably simplified because the membrane has just to be wound.

Owing to the measures presented in FIG. 2, the dead spaces shown in FIG. 1 are eliminated and the reverse osmosis membrane (3) can be produced very easily without the separated telescope star (4). The hydraulic connections can be configured in a simple manner because the reverse osmosis connections are positioned at one side.

FIG. 3 shows the dimensions of the intended membranes in three sizes and the associated three workflows, and it is the aim of the invention independently of any technological development to provide a membrane having a uniform diameter for all of the three membrane sizes.

It is also illustrated that the permeate bores (10) begin directly after the lateral permeate pocket bondings (11). To maximize the membrane area available for filtration, the surrounding permeate pocket bonding (11) should not exceed the width of about 30 mm.

The permeate bores (10) can be distributed either evenly or asymmetrically over the length of the permeate collection tube (9) to achieve an even better flow through the permeate collection tube (9) in the latter case.

Moreover, FIG. 3 shows a sealing element (19) which is not an integral part of the membrane. Preferably, the sealing element consists of a soft plastic with a width corresponding approximately to the permeate-pocket bonding width lk. With advantage the seal has a smooth side positioned on the membrane with a preload and an anti-slip effect due to the material, and a side with a sealing effect in the collar (18) and with fine, easily formable lips which establish the seal in the collar (18).

The membrane element is without an anti-telescoping star (4) as this is part of the membrane collar (18). The membrane can thereby be produced in a very simple manner and at low costs.

FIG. 4 shows the assembly of a reverse osmosis module (1) consisting of the module bottom (20), the module tube (2), and the module lid (22). The module tube (2) is fastened by means of flange mounting (21) via the bore (28) by means of screws (not shown here). At the same time the module bottom (20) is a hydraulic connection unit to which all of the supply and discharge routes (12, 13, 14) can be connected.

### FIG. 4.1

The module lid (22) is fastened by means of the lid fastening ring (24) via a bulge (23) of the module tube. For reasons of safety, the lid fastening ring (24) can be secured by means of a ring holder (25) at a distance and also against possible detachment. The module lid (22) is sealed by means of a surrounding seal ring (30).

FIGS. 4/4.1 shows a permeate outlet (14) at both sides.

It is also possible to install a plug (15) at the upper end of the permeate collection tube (9) so that the permeate is exclusively discharged at the connection (14) of the module bottom (20). FIG. 4.1 shows a two-part connection unit consisting of module bottom (20) and the membrane collar (18). The membrane is inserted with the permeate collection tube (9) and the seal rings (38) and also over the whole outer diameter by means of the membrane seal (19). The feed water supply, extending from the connection (12), is first guided into the annular feed-water inflow chamber (35) of the module bottom (20) and is guided from that place via the ring-gap feed-water outflow (26) and the annular gap supply (39) at a high speed and twist into the annular gap (32), to terminate at the upper end of the membrane (3) into the feed-water channels (8). At the lower end of the membrane the liquid leaves the membrane (3) as a concentrate via the annular concentrate outflow chamber (34) and the reverse-osmosis module (1) via connection (13).

FIG. 4.1 also shows the star (4) which is integrated in the module collar (18) and which prevents telescoping of the membrane.

FIG. 4.2 shows the membrane seal (19) in the installed state; the module tube (2) is sealed via module seal (31) on the module bottom (20). With the help of a Z-shaped bulge on the module tube (2) said tube is fastened with the flange plate (21). There is also the possibility of producing the complete reverse-osmosis module (1) as a single-use article with integrated membrane.

1. A reverse-osmosis module comprising:
a module tube with a module bottom and a module lid,
a reverse osmosis membrane arranged in the module tube and comprising a permeate collection tube, and
the reverse osmosis membrane has a fixed predetermined diameter and a length selected from predetermined length values.

2. The reverse osmosis module according to claim 1,
wherein the predetermined diameter is between 4.7 inches and 5.0 inches, preferably 4.9 inches, and the possible length values are about 40 inches, 23 inches and 12 inches.

3. The reverse osmosis module according to claim 1
wherein the capacity of the reverse osmosis membrane is about 500 l/h, 250 l/h, and 100 l/h.

4. The reverse osmosis module according to claim 1 wherein the membrane areas of the reverse osmosis membranes are 15 m², 6.6 m² and 2.8 m².

5. The reverse osmosis module according to claim 1 wherein the transmembranic flow is between 30 l/m² and 40 l/m², preferably about 33 l/m².

6. The reverse osmosis module according to claim 1 wherein the reverse osmosis membrane is inserted with an end section into a membrane collar and is sealed relative thereto with a ring seal, the membrane collar being fastened to the module bottom and comprising an anti-telescope star.

7. The reverse osmosis module according to claim 1 wherein the module bottom comprises a feed-water supply bore, which terminates in a ring gap underneath the membrane collar, a concentrate discharge bore which terminates radially inside the membrane collar underneath the reverse-osmosis membrane, and a bore connected to the end of the permeate collection tube.

8. The reverse osmosis module according to 1 wherein the module lid also comprises a bore which is connected to the other end of the permeate collection tube.

9. The reverse osmosis module according to claim 7 wherein an end of the permeate collection tube can be closed by a removable plug.

10. The reverse osmosis module according to claim 9, the permeate collection tube comprising permeate bores wherein the plug extends up tot he first permeate bore.
